(19) United States
(12) Patent Application Publication
(10) Pub. No.: US 2025/0208718 A1
(43) Pub. Date: Jun. 26, 2025

(54) INTERACTIVE REGIONS OF AUDIOVISUAL SIGNALS

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 18/845,711

(22) PCT Filed: Mar. 29, 2022
(86) PCT No.: PCT/US2022/022345

§ 371 Date: Sep. 10, 2024

(51) Int. Cl. G06F 3/01; G06F 3/04842; G06F 3/0485

(52) U.S. Cl. CPC G06F 3/017; G06F 3/04842; G06F 3/0485

(57) ABSTRACT

In some examples, an electronic device includes an image sensor and a controller. The controller detects a user gesture within a first audiovisual signal received via the image sensor. The first audiovisual signal is an audiovisual signal of a first application. In response to a determination that the user gesture indicates a first region of the first audiovisual signal, the controller generates a second audiovisual signal having an interactive region. The interactive region has coordinates equivalent to coordinates of the first region of the first audiovisual signal. The controller causes display, transmission, or a combination thereof, of the second audiovisual signal in place of the first audiovisual signal. The second audiovisual signal includes the first audiovisual signal and shared content of a second application disposed within the interactive region.

### BACKGROUND

Electronic devices such as notebooks, laptops, desktops, tablets, and smartphones include executable code that enables users to attend remote meetings and share content with an audience (e.g., a videoconferencing application). A user of an electronic device utilizing the executable code that enables remote meetings shares content via audiovisual signals. An audiovisual signal, as used herein, is an electronic signal that includes audio content, image content, or a combination thereof. The content includes content of another application of the electronic device, an image of the user, or a combination thereof.

### BRIEF DESCRIPTION OF THE DRAWINGS

Various examples are described below referring to the following figures.

FIG. 1 is a block diagram of an electronic device for generating interactive regions of audiovisual signals, in accordance with various examples.

FIG. 2 is a flow diagram of a method for an electronic device to generate interactive regions of audiovisual signals, in accordance with various examples.

FIG. 3 is a block diagram of an electronic device for generating interactive regions of audiovisual signals, in accordance with various examples.

FIG. 4 is a block diagram of an electronic device for generating interactive regions of audiovisual signals, in accordance with various examples.

FIG. 5 is a block diagram of an electronic device for generating interactive regions of audiovisual signals, in accordance with various examples.

FIG. 6 is a block diagram of an electronic device for generating interactive regions of audiovisual signals, in accordance with various examples.

### DETAILED DESCRIPTION

As described above, electronic devices include executable code that enables users to attend remote meetings and share content of another application of the electronic device, an image of the user, or a combination thereof, with an audience. An application, as used herein, refers to executable code implemented by machine-readable instructions, which, when executed by a controller of the electronic device, causes the controller to perform tasks associated with the application (e.g., word processing, data processing, video streaming, videoconferencing). In instances where the user shares content of another application, the executable code that enables remote meetings causes display of the content of the another application via a first window of a graphical user interface (GUI) and display of the image of the user via a second window of the GUI. The executable code causes the display of the first window to be greater in dimension than the second window. The second window is a fractional portion of the dimensions of the first window and disposed along a perimeter of a display device, for instance. The audience may either look at the first window or the second window. The separate windows impede effective communication because, in instances where the audience focuses on the shared content, the audience loses context communicated via facial expressions, hand gestures, and body language of users presented in the second window. In instances where the audience focuses on the second window, the audience is unable to view the shared content. While an audience member may adjust a disposition of the second window relative to the first window, the action is disruptive to the audience member experience and the experience of other audience members and the user.

This description describes an electronic device that includes an image sensor to capture an audiovisual signal that depicts a user. The electronic device generates an interactive audiovisual signal having an interactive region. The interactive audiovisual signal includes the audiovisual signal that depicts the user. In some examples, the electronic device causes a display device to display the interactive audiovisual signal within a GUI of an application. The GUI enables the user to place content within the interactive region of the interactive audiovisual signal, view features of a hand, or a combination thereof. The electronic device detects a user gesture via the image sensor. The electronic device determines whether the user gesture is depicted within coordinates associated with the interactive region of the interactive audiovisual signal. In response to a determination that the user gesture is depicted within the coordinates associated with the interactive region, the electronic device adjusts a content of the interactive region based on the user gesture. The user gesture indicates that a location of the content within the interactive region is to be adjusted, the content is to be removed from the interactive region, a dimension of the content is to be adjusted, or a combination thereof, for example.

By generating the interactive audiovisual signal, the electronic device enhances the user and the audience experience by enabling the audience to simultaneously view content shared by the user and the user. By providing the GUI to organize content for viewing within the interactive audiovisual signal, the electronic device enhances the user and the audience experience by facilitating presentation of content during a meeting. By providing the GUI to display features of the hand, the electronic device enhances the user experience by enabling the user to control the content within the interactive region using gestures.

In some examples in accordance with the present description, an electronic device is provided. The electronic device includes an image sensor and a controller. The controller detects a user gesture within a first audiovisual signal received via the image sensor. The first audiovisual signal is an audiovisual signal of a first application. In response to a determination that the user gesture indicates a first region of the first audiovisual signal, the controller generates a second audiovisual signal having an interactive region. The interactive region has coordinates equivalent to coordinates of the first region of the first audiovisual signal. The controller causes display, transmission, or a combination thereof, of the second audiovisual signal in place of the first audiovisual signal. The second audiovisual signal includes the first audiovisual signal and shared content of a second application disposed within the interactive region.

In other examples in accordance with the present description, an electronic device is provided. The electronic device includes an image sensor and a controller. The controller generates an interactive audiovisual signal. The interactive audiovisual signal includes an interactive region that includes shared content of a first application and a non-interactive region that includes an original audiovisual signal of a second application. The original audiovisual signal is received via the image sensor. The controller causes display, transmission, or a combination thereof, of the interactive audiovisual signal via the second application. The controller detects, via the image sensor, a user gesture within coordinates of the interactive region. In response to the user gesture, the controller adjusts the shared content.

In other examples in accordance with the present description, a non-transitory machine-readable medium is shown. The term “non-transitory,” as used herein, does not encompass transitory propagating signals. The non-transitory machine-readable medium stores machine-readable instructions which, when executed by a controller of an electronic device, cause the controller to generate an interactive audiovisual signal having multiple interactive regions. The interactive audiovisual signal includes an original audiovisual signal of a first application. The original audiovisual signal is received via an image sensor of the electronic device. The machine-readable instructions, when executed by the controller, cause the controller to cause, via a display device of the electronic device, display of the interactive audiovisual signal, and detect, via the image sensor, a user gesture within a first interactive region of the multiple interactive regions. The user gesture indicates to include shared content of a second application within a second interactive region of the multiple interactive regions of the interactive audiovisual signal, and cause transmission, via a network interface of the electronic device, of the interactive audiovisual signal in place of the original audiovisual signal of the first application. The interactive audiovisual signal includes the shared content within the second interactive region.

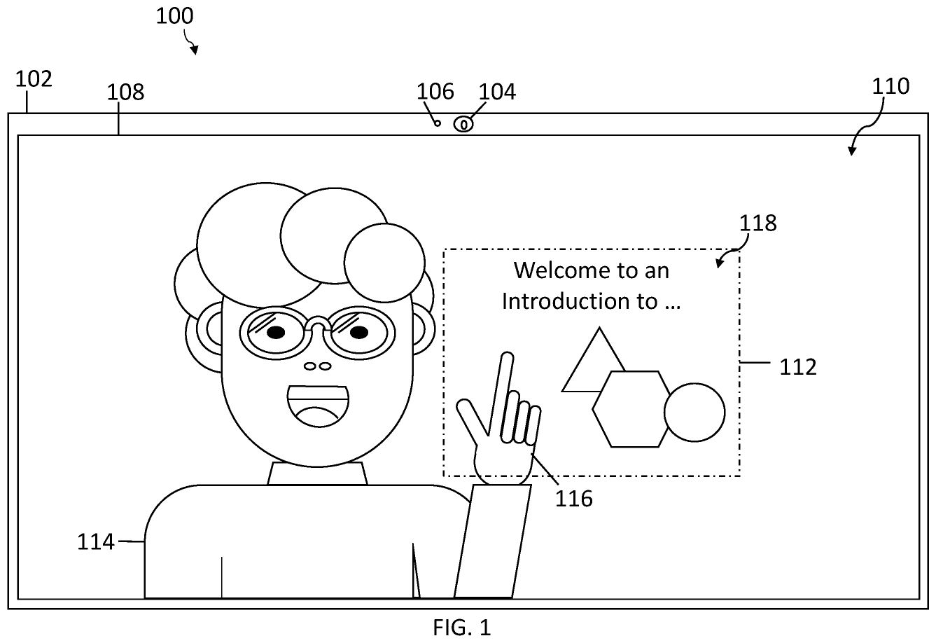

Referring now to FIG. 1, a block diagram of an electronic device 100 for generating interactive regions of audiovisual signals is shown, in accordance with various examples. The electronic device 100 is a desktop, laptop, notebook, tablet, smartphone, or other suitable computing device able to generate interactive regions of audiovisual signals, for example. The electronic device 100 includes a display device 102, an image sensor 104, and an audio device 106. The display device 102 is any suitable device for displaying data of the electronic device 100. The display device 102 is a liquid crystal display (LCD), a light-emitting diode (LED) display, a plasma display, or a quantum dot (QD) display, for example. The image sensor 104 is any suitable device that converts an optical image into an electronic signal (e.g., an image signal). The image sensor 104 is a time of flight sensor, an infrared (IR) camera, or other suitable camera, for example. The audio device 106 is any suitable device that converts audio into an electronic signal (e.g., an audio signal). The audio device 106 is a microphone or other suitable device for capturing audio, for example.

While the image sensor 104 is shown as an integrated component of the display device 102, in other examples, the image sensor 104 is an external component coupled to the electronic device 100 via a wired (e.g., Universal Serial Bus (USB)) or a wireless (e.g., WI-FI®, BLUETOOTH®) connection. While the audio device 106 is shown as an integrated component of the display device 102, in other examples, the audio device 106 is a component separate from the display device 102. For example, the audio device 106 is disposed within a chassis of the electronic device 100 that houses an input device (e.g., keyboard, touchpad). In another example, the audio device 106 is an external component coupled to the electronic device via a wired (e.g., USB, audio jack) or a wireless (e.g., WI-FI®, BLUETOOTH®) connection. In some examples, the audio device 106 is an integrated component of the image sensor 104.

The display device 102 includes a window 108 of a GUI. The window 108 displays image content of an audiovisual signal of an application associated with the GUI. The application is a videoconferencing application, a video recording application, or other suitable application for generating audiovisual signals. The window 108 includes regions 110, 112. A region 110 includes a depiction of a user 114. The depiction of the user 114 is captured via the image sensor 104, for example. A region 112 includes a depiction of a user gesture 116 and a shared content 118. The region 112 is an interactive region of the audiovisual signal, as indicated by the dotted border. The shared content 118 is a presentation associated with a second application, for example. In other examples, the shared content 118 is a view of a desktop of the electronic device 100, a window associated with another application, an image, or any other content accessible by to the electronic device 100.

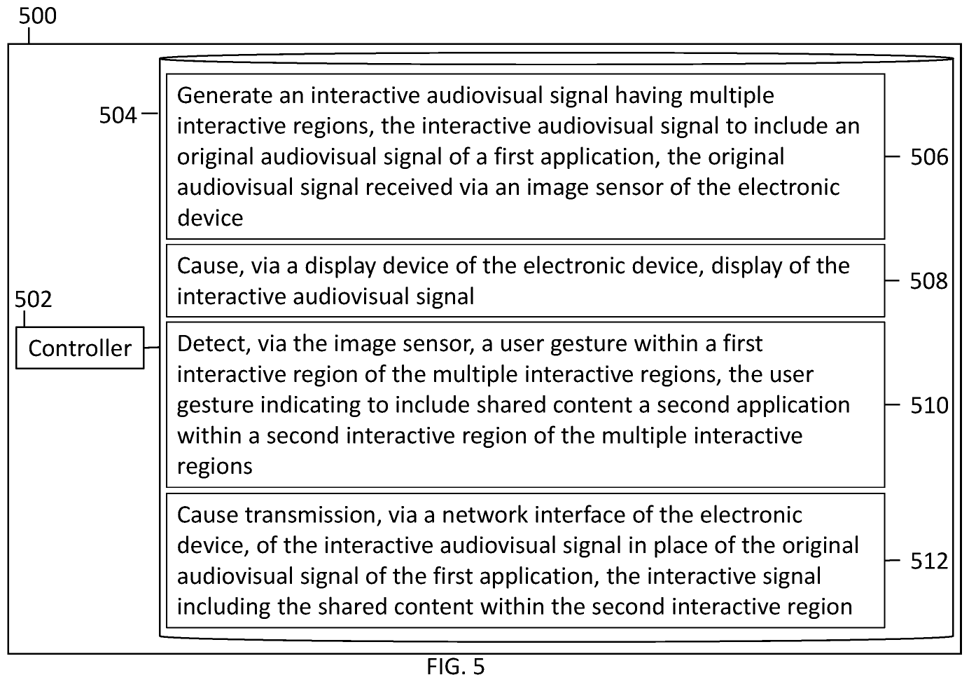

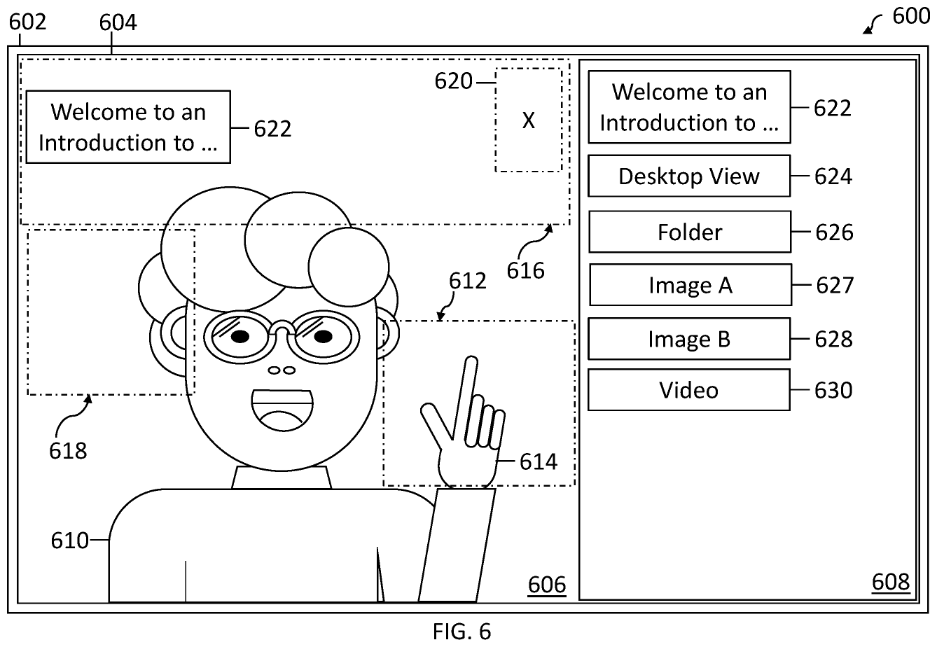

As described above, the electronic device 100 includes the image sensor 104 and the audio device 106 to capture the audiovisual signal that depicts the user 114. The electronic device 100 generates the interactive audiovisual signal that includes the depiction of the user 114 within the region 110 and depiction of the shared content 118 within the region 112 using the techniques described below with respect to FIG. 5 or 6, for example. While the user gesture 116 is visible within the region 112, in other examples, an opacity of the shared content 118 blocks an audience view of the user gesture 116.

In some examples, the electronic device 100 detects the user gesture 116 via the image sensor 104. For example, the electronic device 100 detects the user gesture 116 utilizing hand detection techniques. The electronic device 100 decomposes an image signal of the audiovisual signal captured via the image sensor 104 utilizing a pre-processing technique, in various examples. Decomposing, as used herein, reduces objects of the image signal to edge-like structures. The pre-processing techniques include grayscaling, blurring, sharpening, thresholding, resizing, cropping, or a combination thereof, for example. The electronic device 100 utilizes the hand detection technique to determine whether low intensity regions of the decomposed image signal include features that indicate a hand. The features include a palm, a finger, a joint of a finger, or a combination thereof, for example.

In various examples, the electronic device 100 determines a distance between two features to detect the user gesture 116. For example, the electronic device 100 determines that a distance between a tip of a thumb and a tip of an index finger is greater than a threshold distance. In response to a determination that the distance is greater than the threshold distance, the electronic device 100 determines that the user gesture 116 indicates that a dimension of the shared content 118 is to be increased. In some examples, the electronic device 100 compares the distance to a data structure that includes multiple distances, gestures associated with the multiple distances, respectively, actions to perform in response to a determination that the user gesture 116 is a gesture of the gesture associated with the distance, or a combination thereof. In other examples, the electronic device 100 determines a first distance between a first feature and a second feature and a second distance between a third feature and a fourth feature to detect the user gesture 116.

In other examples, the electronic device 100 utilizes a machine learning technique to detect the user gesture 116. For example, the electronic device 100 utilizes the machine learning technique to detect a hand of the user 114. The machine learning technique includes the hand detection techniques described above, for example. Using the machine learning technique, in some examples, the electronic device 100 compares the features of the hand to multiple templates to determine the user gesture 116. The multiple templates include gestures that may be used to interact with the interactive audiovisual signal. The gestures include a finger point, a multi-finger point, a finger swipe, a multi-finger swipe, a finger pinch, a multi-finger pinch, a palm-forward wave, a backhand-to-palm wave, a directional finger swipe, a directional finger pinch, a two-handed gesture, or any other suitable gesture for adjusting content within an interactive region of an audiovisual signal, for example. The two-handed gesture is a first hand moving in a first direction and a second hand moving in a second direction, for example. The first direction is in a different direction than the second direction in some examples. In another example, the two-handed gesture is a first hand moving in a direction and a second hand stationary.

For example, the electronic device 100 utilizes a machine learning technique that implements a convolution neural network (CNN) to determine whether the image signal of the audiovisual signal includes a hand of the user 114. The CNN is trained with a training set that includes multiple images of hands, for example. The multiple images include hands having different gestures. Utilizing the trained CNN, the electronic device 100 identifies the user gesture 116.

In another example, the electronic device 100 detects the user gesture 116 using a CNN to perform a segmentation technique. Using the segmentation technique, the electronic device 100 divides a frame of the image signal into pixel groupings. The electronic device 100 uses the CNN to identify tangible objects of the pixel groupings, features of the tangible objects, boundaries of the tangible objects, or a combination thereof. The electronic device 100 uses the machine learning technique to distinguish the user gesture 116 from objects depicted in a background of the frame.

As described above, the electronic device 100 determines whether the user gesture 116 is depicted within coordinates associated with the region 112 of the interactive audiovisual signal. The coordinates associated with the region 112 include an anchor point, a specified height, a specified width, or a combination thereof, for example. In another example, the coordinates associated with the region 112 include multiple anchor points. An anchor point, as used herein, is a coordinate that represents a location of a corner of the region 112. The electronic device 100 compares coordinates of the user gesture 116 to the coordinates associated with the region 112 to determine whether the user gesture 116 is depicted within a boundary specified by the coordinates of the region 112, for example. In response to a determination that the user gesture 116 is depicted within the coordinates associated with the region 112, the electronic device 100 adjusts the shared content 118 based on the user gesture 116. For example, the electronic device 100 determines that the user gesture 116 is a finger point. The electronic device 100 accesses a data structure that indicates an action to perform in response to the finger point. In some examples, the data structure is generated utilizing a GUI, as described below with respect to FIG. 6.

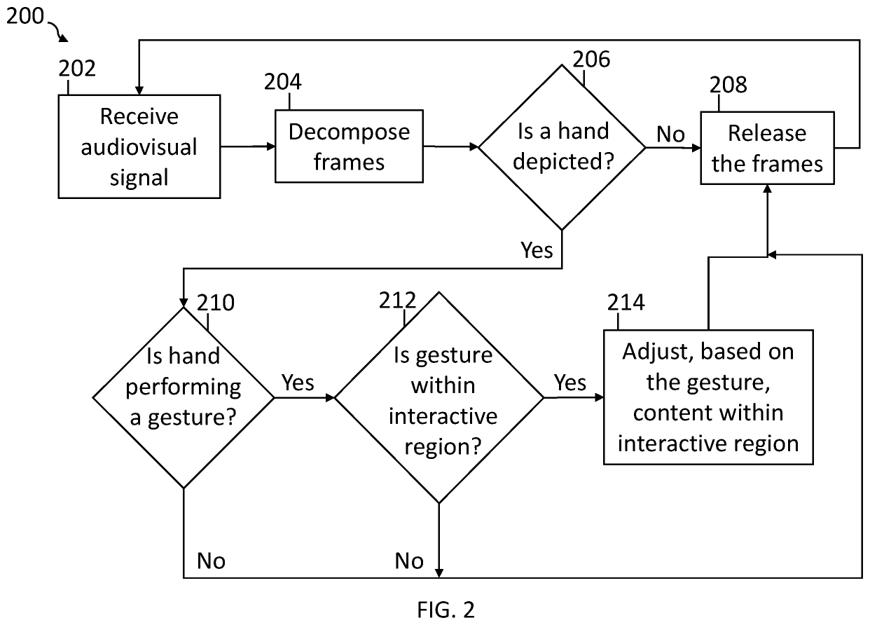

Referring now to FIG. 2, a flow diagram of a method 200 for an electronic device (e.g., the electronic device 100) for generating interactive regions of audiovisual signals is shown, in accordance with various examples. The method 200 includes receiving an audiovisual signal (202). The method 200 also includes decomposing frames of the audiovisual signal (204). Additionally, the method 200 includes determining whether a hand is depicted within a frame (206). In response to a determination the hand is not depicted within the frame, the method 200 includes releasing the frame (208).

In response to a determination that the hand is depicted within the frame, the method 200 includes determining whether the hand is performing a gesture (210). In response to a determination that the hand is not performing a gesture, the method 200 includes releasing the frame (208). In response to a determination that the hand is performing the gesture, the method 200 includes determining whether the gesture is depicted within an interactive region associated with the frame (212). In response to a determination that the gesture is not depicted within the interactive region, the method 200 includes releasing the frame (208) without adjusting content of the frame. In response to a determination that the gesture is depicted within the interactive region, the method 200 includes adjusting, based on the gesture, content within the interactive region (214). The method 200 includes releasing the frame (208), where the released frame includes the adjusted content.

In various examples, the method 200 also includes receiving a request by an application to access an image sensor of the electronic device. For example, execution of a videoconferencing application, a video recording application, or other application for generating audiovisual or image signals, includes a request for the videoconferencing application, the video recording application, or the other application for generating audiovisual or image signals to access the image sensor. In response to the electronic device granting the request, the method 200 begins receiving the audiovisual signal.

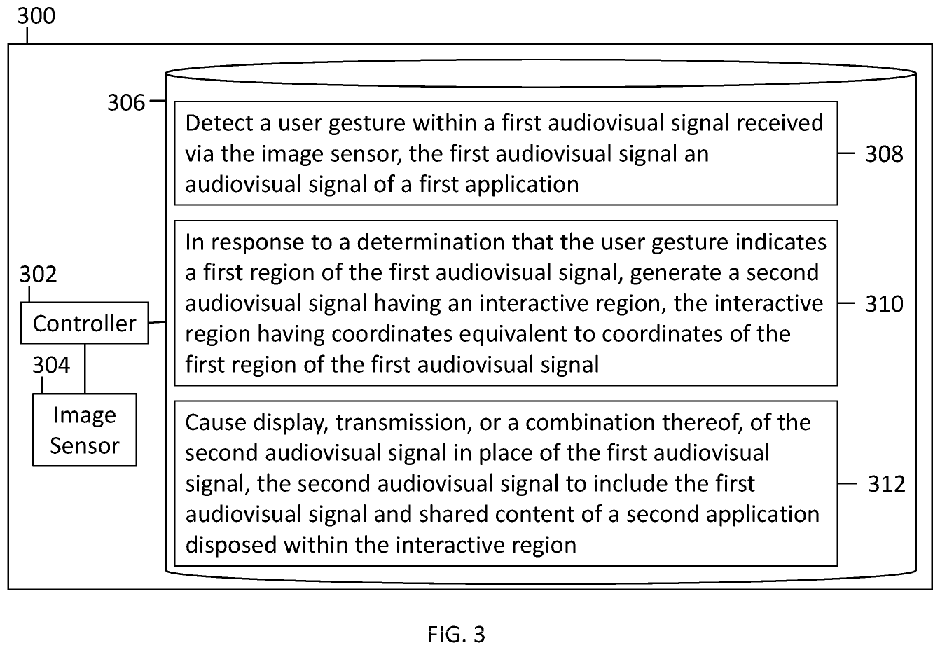

In some examples, the method 200 includes decomposing frames of the audiovisual signal, determining whether a hand is depicted within a frame, determining whether the hand is performing a gesture, determining whether the gesture is depicted within the interactive region, or a combination thereof, using the techniques described above with respect to FIG. 1. In other examples, the method 200 includes adjusting, based on the gesture, content within the interactive region using techniques described above with respect to FIG. 1 or below with respect to FIGS. 3-6.

Referring now to FIG. 3, a block diagram of an electronic device 300 for generating interactive regions of audiovisual signals is shown, in accordance with various examples. The electronic device 300 is the electronic device 100, for example. The electronic device 300 includes a controller 302, an image sensor 304, and a storage device 306. The controller 302 is a microcontroller, a microcomputer, a programmable integrated circuit, a programmable gate array, or other suitable device for managing operations of the electronic device 300 or a component or multiple components of the electronic device 300. For example, the controller 302 is a central processing unit (CPU), a graphics processing unit (GPU), or an embedded security controller (EpSC). In another example, the controller 302 is an embedded artificial intelligence (eAI) of the image sensor 304. The image sensor 304 is any suitable device that converts an optical image into an electronic signal (e.g., an audiovisual signal). The storage device 306 is a hard drive, a solid-state drive (SSD), flash memory, random access memory (RAM), or other suitable memory for storing data or machine-readable instructions of the electronic device 300.

While not explicitly shown, in some examples, the electronic device 300 includes network interfaces, video adapters, sound cards, local buses, peripheral devices (e.g., a keyboard, a mouse, a touchpad, a speaker, a microphone, a display device), or a combination thereof. While the image sensor 304 is shown as an integrated image sensor of the electronic device 300, in other examples, the image sensor 304 is coupled to the electronic device 300 via a wired (e.g., Universal Serial Bus (USB)) or a wireless (e.g., WI-FI®, BLUETOOTH®) connection. The network interfaces enable communication over a network. The network interfaces may include a wired (e.g., Ethernet, USB) or a wireless (e.g., WI-FI®, BLUETOOTH®) connection, for example. The network is a local area network (LAN), a wide area network (WAN), a virtual private network (VPN), a client/server network, an Internet (e.g., cloud), or any other suitable system for sharing content, for example. In various examples, the controller 302 is coupled to the image sensor 304 and the storage device 306.

In some examples, the storage device 306 stores machine-readable instructions 308, 310, 312, which, when executed by the controller 302, cause the controller 302 to perform some or all of the actions attributed herein to the controller 302. The machine-readable instructions 308, 310, 312, when executed by the controller 302, cause the controller 302 to perform some or all of the method 200, for example.

In various examples, the machine-readable instructions 308, 310, 312, which, when executed by the controller 302, cause the controller 302 to generate interactive regions of audiovisual signals. The machine-readable instruction 308, when executed by the controller 302, causes the controller 302 to detect a user gesture (e.g., the user gesture 116) within a first audiovisual signal received via the image sensor 304. The first audiovisual signal is an audiovisual signal of a first application. In response to a determination that the user gesture indicates a first region of the first audiovisual signal, the machine-readable instruction 310, when executed by the controller 302, causes the controller 302 to generate a second audiovisual signal having an interactive region (e.g., the region 112). The interactive region has coordinates that are equivalent to coordinates of the first region of the audiovisual signal. The machine-readable instruction 312, when executed by the controller 302, causes the controller 302 to cause display, transmission, or a combination thereof, of the second audiovisual signal in place of the first audiovisual signal. The second audiovisual signal includes the first audiovisual signal and shared content (e.g., the shared content 118) of a second application disposed within the interactive region.

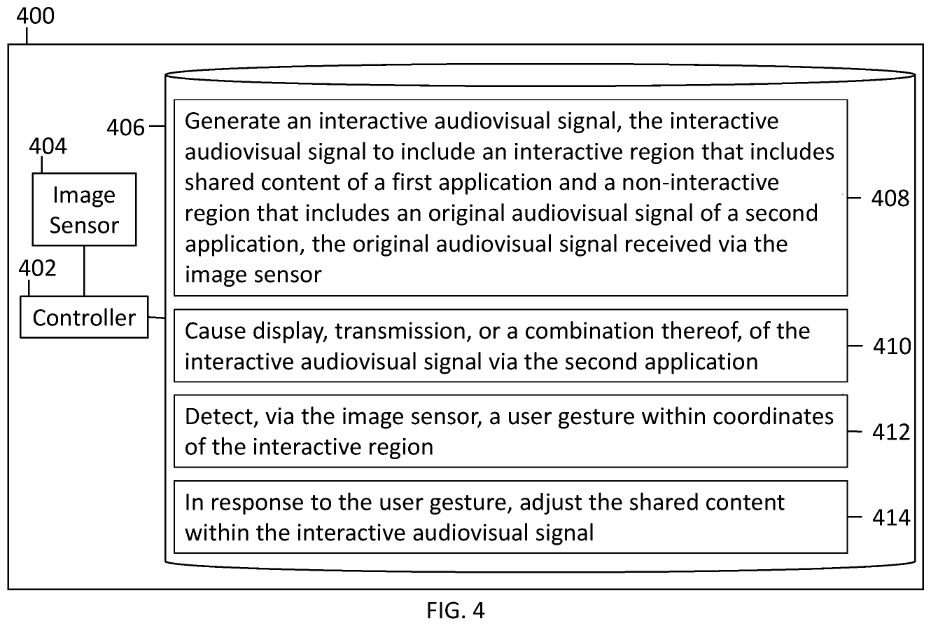

In some examples, the controller 302 determines whether the first audiovisual signal depicts the user gesture using the techniques described above with respect to FIG. 1 or 2. In response to the determination that the audiovisual signal depicts the user gesture, the controller 302 utilizes the techniques described below with respect to FIG. 4, 5, or 6 to generate the interactive region of the second audiovisual signal.

In various examples, the controller 302 detects a second user gesture within the second audiovisual signal. In response to a determination that the second user gesture indicates the interactive region, the controller 302 adjusts the shared content based on the second user gesture. In some examples, the second user gesture indicates that a location of the shared content within the interactive region is to be adjusted, the shared content is to be removed from the interactive region, or a dimension of the shared content is to be adjusted. For example, the second user gesture is a backhand-to-palm wave. The controller 302 accesses a data structure that indicates an action to perform in response to the backhand-to-palm wave. In response to the data structure indicating that the backhand-to-palm wave indicates that the shared content is to be removed from the interactive region, the controller 302 removes the shared content from the interactive region.

In other examples, the second user gesture indicates a direction to scroll the shared content. In response to the second user gesture indicating a forward direction to scroll the shared content, the controller 302 adjusts the shared content to show a next page or a next slide of the shared content, for example. In response to the second user gesture indicating a backward direction to scroll the shared content, the controller 302 adjusts the shared content to show a previous page or a previous slide of the shared content, for example.

In some examples, the second audiovisual signal includes multiple interactive regions. In response to a determination that the second user gesture indicates a second interactive region of the multiple interactive regions, the controller 302 disposes a second shared content of a third application within the second interactive region.

Referring now to FIG. 4, a block diagram of an electronic device 400 for generating interactive regions of audiovisual signals is shown, in accordance with various examples. The electronic device 400 is the electronic device 100, 300, for example. The electronic device 400 includes a controller 402, an image sensor 404, and a storage device 406. The controller 402 is the controller 302, for example. The image sensor 404 is the image sensor 304, for example. The storage device 406 is the storage device 306, for example. In various examples, the controller 402 is coupled to the image sensor 404 and the storage device 406.

In some examples, the storage device 406 stores machine-readable instructions 408, 410, 412, 414, which, when executed by the controller 402, cause the controller 402 to perform some or all of the actions attributed herein to the controller 402. The machine-readable instructions 408, 410, 412, 414, when executed by the controller 402, cause the controller 402 to generate interactive regions of audiovisual signals, for example. The machine-readable instruction 408, when executed by the controller 402, causes the controller 402 to generate an interactive audiovisual signal. The interactive audiovisual signal includes an interactive region (e.g., the region 112) that includes shared content (e.g., the shared content 118) of a first application and a non-interactive region (e.g., the region 110) that includes an original audiovisual signal of a second application. The original audiovisual signal is received via the image sensor 404. The machine-readable instruction 410, when executed by the controller 402, causes the controller 402 to cause display, transmission, or a combination thereof, of the interactive audiovisual signal via the second application. The machine-readable instruction 412, when executed by the controller 402, causes the controller 402 to detect, via the image sensor 404, a user gesture (e.g., the user gesture 116) within coordinates of the interactive region. In response to the user gesture, the machine-readable instruction 414, when executed by the controller 402, causes the controller 402 to adjust the shared content within the interactive audiovisual signal.

In some examples, the controller 402 utilizes the techniques described below with respect to FIG. 5 or 6 to generate the interactive audiovisual signal. In various examples, the controller 402 determines whether the interactive audiovisual signal depicts the user gesture using the techniques described above with respect to FIG. 1, 2, or 3, for example.

As described above with respect to FIG. 1, in various examples, the interactive region is surrounded by the non-interactive region. For example, a display device (e.g., the display device 102) has a resolution of 1600 horizontal pixels by 1200 vertical pixels. The non-interactive region has dimensions of 1600 horizontal pixels by 1200 vertical pixels (e.g., full screen). The interactive region has dimensions of 400 horizontal pixels by 300 vertical pixels. The interactive region is referred to as overlaying the non-interactive region because the interactive region surrounds the non-interactive region.

In some examples, an anchor point of the interactive region is disposed within a threshold number of pixels of a central axis of the non-interactive region. The central axis may be a horizontal central axis, a vertical central axis, or a combination thereof. For example, using the display device having the resolution of 1600×1200, a full screen, non-interactive region has a horizontal central axis that intersects the 600th vertical pixel and a vertical central axis that intersects the 800th horizontal pixel. In response to the threshold number of pixels having a value of 100 pixels, an upper left hand corner of the interactive region is located at a coordinate that includes an 850th horizontal pixel (e.g., a coordinate (850, y)), for example. In another example, in response to the threshold number of pixels having a value of 50 pixels, an upper left hand corner of the interactive region is located at a coordinate that includes an 625th vertical pixel (e.g., a coordinate (x, 625). In another example, in response to a horizontal threshold number of pixels having a value of 50 pixels and a vertical threshold number of pixels having a value of 200 pixels, an upper left hand corner of the interactive region is located at a coordinate that includes an 825th horizontal pixel and a 725th vertical pixel (e.g., a coordinate (825, 725)).

In various examples, the interactive audiovisual signal includes a second interactive region, the second interactive region is disposed on a side opposite the central axis of the non-interactive region to the first interactive region. For example, the second interactive region is disposed on a first side of a vertical central axis of the non-interactive region and the first interactive region is disposed on a second side of the vertical central axis of the non-interactive region. In another example, the second interactive region is disposed on a first side of a horizontal central axis of the non-interactive region and the first interactive region is disposed on a second side of the horizontal central axis of the non-interactive region.

In some examples, the controller 402 detects, via the image sensor 404, a second user gesture within coordinates of the second interactive region. In response to the second user gesture, the controller 402 disposes a second shared content within the second interactive region. The second shared content is a content of a third application. For example, the first shared content is a first presentation and the second shared content is a photograph or a video.

Referring now to FIG. 5, a block diagram depicting an electronic device 500 for generating interactive regions of audiovisual signals is shown, in accordance with various examples. The electronic device 500 is the electronic device 100, 300, 400, for example. The electronic device 500 includes a controller 502 and a non-transitory machine-readable medium 504. The controller 502 is the controller 302, 402, for example. The non-transitory machine-readable medium 504 is the storage device 306, 406, for example. In various examples, the controller 502 is coupled to the non-transitory machine-readable medium 504.

In some examples, the non-transitory machine-readable medium 504 stores machine-readable instructions 506, 508, 510, 512, which, when executed by the controller 502, cause the controller 502 to perform some or all of the actions attributed herein to the controller 502. The machine-readable instructions 506, 508, 510, 512, when executed by the controller 502, cause the controller 502 to generate interactive regions of audiovisual signals, for example.

In various examples, the machine-readable instruction 506, when executed by the controller 502, causes the controller 502 to generate an interactive audiovisual signal having multiple interactive regions. The interactive audiovisual signal includes an original audiovisual signal of a first application. The original audiovisual signal is received via an image sensor (e.g., the image sensor 304, 404). The machine-readable instruction 508, when executed by the controller 502, causes the controller 502 to cause display of the interactive audiovisual signal to a display device (e.g., the display device 102) of the electronic device 500. The machine-readable instruction 510, when executed by the controller 502, causes the controller 502 to detect, via the image sensor, a user gesture (e.g., the user gesture 116) within a first interactive region of the multiple interactive regions. The user gesture indicates to include shared content (e.g., the shared content 118) of a second application within a second interactive region (e.g., the region 112) of the multiple interactive regions. The machine-readable instruction 512, when executed by the controller 502, causes the controller 502 to cause transmission, via a network interface of the electronic device 500, of the interactive audiovisual signal in place of the original audiovisual signal of the first application. The interactive audiovisual signal includes the shared content within the second interactive region.

In some examples, the controller 502 utilizes the techniques described above with respect to FIG. 4 or described below with respect to FIG. 6 to generate the interactive audiovisual signal. In various examples, the controller 502 determines whether the interactive audiovisual signal depicts the user gesture using the techniques described above with respect to FIG. 1, 2, 3, or 4, for example.

In various examples, the controller 502 generates the interactive audiovisual signal in response to detection of selection of a command of the first application. The command is to enable sharing content via the first application. For example, a user selects a menu option for sharing content within a videoconferencing application. In response to the controller 502 detecting the selection of the menu option for sharing content, the controller 502 generates the interactive audiovisual signal utilizing techniques described above with respect to FIG. 4 or described below with respect to FIG. 6. In some examples, the controller 502 causes, via the display device, display of a GUI of a third application in response to detection of selection of the command of the first application. The GUI is to include a first area to enable selection of content to share and a second area to display the interactive audiovisual signal. The controller 502 causes, via the display device, display of shared content of the second application within the first interactive region in response to detection of selection, via the first area, of the shared content. In response to detection, via the image sensor, of the user gesture within the first interactive region, the controller 502 adjusts a location of the shared content from the first interactive region to the second interactive region.

In some examples, the first interactive region has a first set of coordinates and the second interactive region has a second set of coordinates. The second set of coordinates have no overlap with the first set of coordinates. In various examples, the controller 502 adjusts a visibility of the first interactive region prior to transmission of the interactive audiovisual signal. For example, the controller 502 adjusts an opacity of the first interactive region so that the content of the first interactive region is not visible by the audience.

Referring now to FIG. 6, a block diagram of an electronic device 600 for generating interactive regions of audiovisual signals is shown, in accordance with various example. The electronic device 600 is the electronic device 100, 300, 400, 500, for example. The electronic device includes a display device 602, for example. The display device 602 is the display device 102, for example.

The display device 602 includes a window 604 of a GUI. The GUI is a GUI of an application that enables a user 610 (e.g., the user 114) to generate audiovisual signals having interactive regions. The window 604 displays image content of an audiovisual signal of an application associated with the GUI. The window 604 includes areas 606, 608. An area 606 displays the image content of the audiovisual signal of a videoconferencing application, for example. The area 606 is referred to as a non-interactive region, in some examples. An area 608 enables selection of content to share, for example. The area 606 includes regions 612, 616, 618, 620. The area 606 includes a depiction of the user 610. The depiction of the user 610 is captured via an image sensor (e.g., the image sensor 104, 304, 404), for example. A region 612 includes a depiction of a user gesture 614 (e.g., the user gesture 116). The region 612 is an interactive region of the audiovisual signal, as indicated by the dotted border. A region 618 is another interactive region of the audiovisual signal, as indicated by the dotted border. A region 616 is another interactive region of the audiovisual signal, as indicated by the dotted border. A region 620 is another interactive region of the audiovisual signal, as indicated by the dotted border. The area 608 includes content 622, 624, 626, 627, 628, 630. A content 622 is a presentation, for example. A content 624 is a desktop view of the electronic device 600, for example. A content 626 is a folder stored to a storage device (e.g., the storage device 306, 406, the non-transitory machine-readable medium 504) of the electronic device 600, for example. A content 627 is an Image A stored to the storage device of the electronic device 600, for example. A content 628 is an Image B stored to the storage device of the electronic device 600, for example. A content 630 is a video stored to the storage device of the electronic device 600, for example.

In various examples, as described above with respect to FIG. 5, the electronic device 600 generates the interactive audiovisual signal in response to detection of selection of the command of the first application. The command is to enable sharing content via the first application. For example, the user 610 selects a menu option for sharing content within a videoconferencing application. In response to the selection of the menu option for sharing content, the electronic device 600 causes, via the display device 602, display of the GUI having the window 604. The area 608 enables selection of content to share, and the area 606 displays the interactive audiovisual signal that is generated in response to user selections. For example, in response to the user 610 indicating that the content 622 is to be shared, the electronic device 600 disposes the content 622 to the region 616. In some examples, the region 616 is a staging region, or a buffer zone. The user 610 disposes multiple content in the region 616 for quick access during the videoconferencing application. In various examples, the electronic device 600 adjusts a visibility of the content in the region 616 prior to transmission. For example, the electronic device 600 adjusts the visibility so that the content in the region 616 is not visible to the audience.

In some examples, the GUI enables the user 610 to specify the coordinates associated with the regions 612, 616, 618, 620. For example, the user 610 uses the GUI to specify an anchor point, a height, a width, or a combination thereof for the regions 612, 616, 618, 620. In another example, the user 610 uses the GUI to specify multiple anchor points for the regions 612, 616, 618, 620. For example, the user 610 uses the GUI to specify a first anchor point for an upper left hand corner of the region 612, a second anchor point for an upper right hand corner of the region 612, a third anchor point for a lower left hand corner of the region 612, and a fourth anchor point for a lower right hand corner of the region 612.

In various examples, the GUI enables the user 610 to specify the user gesture 614 and an action to perform in response to detecting the user gesture 614. In other examples, the GUI enables the user 610 to specify a threshold number of pixels of a central axis of the non-interactive region to locate the regions 612, 616, 618, 620. In some examples, the GUI enables the user 610 to specify a horizontal threshold number of pixels of a horizontal central axis of the non-interactive region to locate the regions 612, 616, 618, 620, a vertical threshold number of pixels of a vertical central axis of the non-interactive region to locate the regions 612, 616, 618, 620, or a combination thereof.

In some examples, the region 612 has a first dimension (e.g., 400×300 pixels) and the region 618 has a second dimension (e.g., 500×200 pixels). A dimension of a first shared content is adjusted to coincide with the first dimension and a dimension of a second shared content is adjusted to coincide with the second dimension. The dimensions may be scaled up or scaled down so that borders of the shared content coincide with, or are disposed within, borders of the interactive region, for example.

As described above with respect to FIG. 1, in some examples, the electronic device 600 accesses a data structure to determine an action to perform in response to the user gesture 614. For example, data of the data structure specifies an association between a two-finger swipe and an instruction to adjust a location of the content within the interactive region from a first location to a second location, where a coordinate of a finger of the user 610 indicates the second location. In another example, data of the data structure specifies an association between a backhand-to-palm wave and an instruction to remove the content from the interactive region from a first location to a second location. In another example, data of the data structure specifies a first association between a first directional finger pinch and an instruction to adjust dimensions of the content from a first dimension to a second dimension, where the second dimension is smaller than the first dimension, and a second association between a second directional finger pinch and an instruction to adjust dimensions of the content from a first dimension to a second dimension, where the second dimension is larger than the first dimension.

Unless infeasible, some or all of the method 200 is performed by a controller (e.g., the controller 302, 402, 502) concurrently or in different sequences and by circuitry of an electronic device (e.g., the electronic device 100, 300, 400, 500, 600), execution of machine-readable instructions of the electronic device, or a combination thereof. For example, the method 200 is implemented by machine-readable instructions stored to a storage device (e.g., the storage device 306, 406, the non-transitory machine-readable medium 504, or another storage device not explicitly shown of the electronic device), circuitry (some of which is not explicitly shown) of the electronic device, or a combination thereof. The controller executes the machine-readable instructions to perform some or all of the method 200, for example.

In some examples, utilizing a GUI (e.g., the GUI having the window 108, 604), a user (e.g., the user 114, the user 610) specifies the coordinates of the interactive regions (e.g., the region 112, the regions 612, 616, 618, 620) of an audiovisual signal to be displayed, transmitted, or a combination thereof, by an electronic device (e.g., the electronic device 100, 300, 400, 500, 600). For example, the user specifies a first interactive region associated with coordinates of an upper left portion of a display device (e.g., the display device 102, 602), a second interactive region associated with coordinates of an upper right portion of the display device, and a third interactive region associated with a central portion of a right half of the display device. In other examples, a manufacturer of the electronic device specifies the interactive regions. In various examples, the electronic device uses a machine learning technique to determine the interactive regions. For example, the electronic device uses the machine learning technique to determine a first region of an audiovisual signal that includes the user. The electronic device uses the machine learning technique to determine a second region of the audiovisual signal that the user uses for hand gestures. The electronic device determines that the second region is an interactive region.

While some components are shown as separate components of the electronic device 300, 400, 500, in other examples, the separate components are integrated in a single package. For example, the storage device 306, 406, is integrated with the controller 302, 402, respectively. The single package may herein be referred to as an integrated circuit (IC) or an integrated chip (IC).

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . ” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
an image sensor; and
a controller to:
detect a user gesture within a first audiovisual signal received via the image sensor, the first audiovisual signal an audiovisual signal of a first application;
in response to a determination that the user gesture indicates a first region of the first audiovisual signal, generate a second audiovisual signal having an interactive region, the interactive region having coordinates equivalent to coordinates of the first region of the first audiovisual signal; and
cause display, transmission, or a combination thereof, of the second audiovisual signal in place of the first audiovisual signal, the second audiovisual signal to include the first audiovisual signal and shared content of a second application disposed within the interactive region.

2. The electronic device of claim 1, wherein the controller is to:
detect a second user gesture within the second audiovisual signal; and
in response to a determination that the second user gesture indicates the interactive region, adjust the shared content based on the second user gesture.

3. The electronic device of claim 2, wherein the second user gesture indicates that a location of the shared content within the interactive region is to be adjusted, the shared content is to be removed from the interactive region, or a dimension of the shared content is to be adjusted.

4. The electronic device of claim 2, wherein the second user gesture indicates a direction to scroll the shared content.

5. The electronic device of claim 2, wherein the second audiovisual signal includes multiple interactive regions, and wherein the controller is to:
in response to a determination that the second user gesture indicates a second interactive region of the multiple interactive regions, dispose a second shared content of a third application within the second interactive region.

6. An electronic device, comprising:
an image sensor; and
a controller to:
generate an interactive audiovisual signal, the interactive audiovisual signal to include an interactive region that includes shared content of a first application and a non-interactive region that includes an original audiovisual signal of a second application, the original audiovisual signal received via the image sensor;
cause display, transmission, or a combination thereof, of the interactive audiovisual signal via the second application;
detect, via the image sensor, a user gesture within coordinates of the interactive region; and
in response to the user gesture, adjust the shared content within the interactive audiovisual signal.

7. The electronic device of claim 6, wherein the interactive region is surrounded by the non-interactive region.

8. The electronic device of claim 6, wherein an anchor point of the interactive region is disposed within a threshold number of pixels of a central axis of the non-interactive region.

9. The electronic device of claim 8, wherein the interactive audiovisual signal includes a second interactive region, the second interactive region disposed on a side opposite the central axis of the non-interactive region to the interactive region.

10. The electronic device of claim 9, wherein the controller is to:
detect, via the image sensor, a second user gesture within coordinates of the second interactive region; and
in response to the second user gesture, dispose a second shared content within the second interactive region, the second shared content a content of a third application.

11. A non-transitory machine-readable medium storing machine-readable instructions, which, when executed by a controller of an electronic device, causes the controller to:
generate an interactive audiovisual signal having multiple interactive regions, the interactive audiovisual signal to include an original audiovisual signal of a first application, the original audiovisual signal received via an image sensor of the electronic device;
cause, via a display device of the electronic device, display of the interactive audiovisual signal;
detect, via the image sensor, a user gesture within a first interactive region of the multiple interactive regions, the user gesture indicating to include shared content of a second application within a second interactive region of the multiple interactive regions of the interactive audiovisual signal; and
cause transmission, via a network interface of the electronic device, of the interactive audiovisual signal in place of the original audiovisual signal of the first application, the interactive audiovisual signal including the shared content within the second interactive region.

12. The non-transitory machine-readable medium of claim 11, wherein the machine-readable instructions, when executed by the controller, cause the controller to generate the interactive audiovisual signal in response to detection of selection of a command of the first application, the command to enable sharing content via the first application.

13. The non-transitory machine-readable medium of claim 12, wherein the machine-readable instructions, when executed by the controller, cause the controller to:
cause, via the display device, display of a graphical user interface (GUI) of a third application in response to detection of selection of the command of the first application, the GUI to include a first area to enable selection of content to share and a second area to display the interactive audiovisual signal;
cause, via the display device, display of shared content of the second application within the first interactive region in response to detection of selection, via the first area, of the shared content; and
in response to detection, via the image sensor, of the user gesture within the first interactive region, adjust a location of the shared content from the first interactive region to the second interactive region.

14. The non-transitory machine-readable medium of claim 11, wherein the first interactive region has a first set of coordinates and the second interactive region has a second set of coordinates, the second set of coordinates having no overlap with the first set of coordinates.

15. The non-transitory machine-readable medium of claim 11, wherein the machine-readable instructions, when executed by the controller, cause the controller to adjust a visibility of the first interactive region prior to transmission of the interactive audiovisual signal.
